(19) United States
(12) Patent Application Publication
(10) Pub. No.: US 2018/0280888 A1
(43) Pub. Date: Oct. 4, 2018

(54) REVERSE OSMOSIS TREATMENT APPARATUS AND REVERSE OSMOSIS TREATMENT METHOD

(71) Applicant: HITACHI, LTD., Tokyo (JP)

(72) Inventors: Koji FUKUZAKI, Tokyo (JP); Makoto ONISHI, Tokyo (JP); Shinichi YOSHIKAWA, Tokyo (JP); Shuji YAMADA, Tokyo (JP); Kotaro KITAMURA, Tokyo (JP); Yasutaka KONDO, Tokyo (JP)

(73) Assignee: HITACHI, LTD., Tokyo (JP)

(21) Appl. No.: 15/936,643

(22) Filed: Mar. 27, 2018

(30) Foreign Application Priority Data
Mar. 31, 2017 (JP) 2017-070416

(51) Int. Cl. B01D 65/02; B01D 61/02; B01D 61/08; B01D 61/12; B01D 63/06; C02F 1/44; B01D 65/06

(52) U.S. Cl. CPC B01D 65/027; B01D 61/022; B01D 61/08; B01D 61/12; B01D 63/063; C02F 1/441; C02F 1/004; B01D 2311/04; B01D 2313/46; B01D 2313/48; B01D 2321/02; B01D 2321/04; B01D 2321/162; B01D 65/06

(57) ABSTRACT

A reverse osmosis treatment apparatus includes a membrane unit including an osmosis membrane module. The membrane unit includes a plurality of banks connected in series, each bank including an osmosis membrane module. At least one of the banks includes a treatment water pipe valve and a concentrated water pipe valve, and a bypass pipe capable of diverting the water to be treated, which is to be supplied to the bank, around the bank and draining the water to be treated and a chemical cleaning pipe capable of supplying the reverse osmosis membrane module disposed in the bank with chemical cleaning water are connected. A reverse osmosis treatment method is for cleaning intermittently a bank having the treatment water pipe valve and the concentrated water pipe valve while continuing the reverse osmosis treatment using the remaining bank.

### BACKGROUND OF THE INVENTION

### 1. Field of the Invention

The present invention relates to a reverse osmosis treatment apparatus to desalinate saltwater such as seawater by reverse osmosis and a reverse osmosis treatment method using the same.

### 2. Description of the Related Art

Reverse osmosis treatment apparatuses to desalinate saltwater by reverse osmosis have been used in various fields, such as desalination of seawater, reuse of wastewater, and production of pure water. A reverse osmosis treatment apparatus typically includes cylindrical reverse osmosis membrane modules. A reverse osmosis membrane module of this type includes multiple reverse osmosis membrane elements holding reverse osmosis membranes, inside a cylindrical pressure vessel.

The reverse osmosis membrane element included in the cylindrical reverse osmosis membrane module has a structure in which the reverse osmosis membranes are spirally wound around a water collection pipe. The multiple reverse osmosis membrane elements in use are typically housed in the pressure vessel and disposed in series. One reverse osmosis membrane module as above or multiple ones connected in parallel via pipes constitutes a bank. Further, one bank of reverse osmosis membrane modules or multiple banks connected in series via pipes form a membrane unit. Typically, reverse osmosis treatment equipment includes multiple membrane units.

The reverse osmosis membrane module performs reverse osmosis treatment on water to be treated flowing in the pressure vessel by the cross flow filtration method, and separates the water to be treated into permeated water containing less ions and concentrated water containing concentrated ions. When the water to be treated flows into one end of the pressure vessel, the concentrated water concentrated by reverse osmosis on the upstream side of the reverse osmosis membranes is discharged from the other end of the pressure vessel. Meanwhile, the permeated water which has permeated the reverse osmosis membranes to the downstream side is collected inside a water collection pipe, and taken out to the outside of the reverse osmosis membrane module.

As for the reverse osmosis membranes included in the reverse osmosis membrane module, sometimes, blocking is caused by organic substances contained in the water to be treated, microorganisms which grow on membrane surfaces, inorganic substances precipitated as scales, or other factors. If pores of the reverse osmosis membrane are blocked, the amount of water production or the removal rate decreases, or in severe cases, a breakthrough occurs. For this reason, periodic cleaning and replacement are necessary. In particular, in performing the reverse osmosis treatment on water to be treated in which microorganisms are likely to grow, such as seawater and sewage treatment water, bio-fouling is a serious problem, which makes it difficult to continue stable reverse osmosis treatment.

As for reverse osmosis treatment apparatuses, there is a multiple-stage type in which banks of reverse osmosis membrane modules are connected in series, a bank at the front stage performs the reverse osmosis treatment on water to be treated and separates concentrated water from it, and a bank at the rear stage further performs the reverse osmosis treatment on the concentrated water. For example, JP2013-126635A (Patent Document 1) describes a technique for multiple-stage reverse osmosis treatment apparatuses for cleaning a first pressure vessel to performs a primary treatment on water to be treated and a second pressure vessel to perform a secondary treatment on the water to be treated subjected to the primary treatment, with cleaning liquid stored in respective cleaning liquid storage tanks.

### SUMMARY OF THE INVENTION

It is difficult to completely prevent fouling of reverse osmosis membranes even if the water to be treated is pretreated with chemicals or the like. As a result of continuing the reverse osmosis treatment over a long period, microbial films and scales accumulate on the reverse osmosis membrane surfaces and the like. For this reason, as for the reverse osmosis membrane module, it is necessary to periodically stop operation of the reverse osmosis membrane module and separate it from the water production line to clean the reverse osmosis membrane module. For the periodic cleaning, typically, chemical cleaning water for cleaning is passed through the reverse osmosis membrane module temporarily separated from the water production line, and the chemical cleaning water which has passed through is drained through a line different from the water production line. In addition, in the case where chemicals such as disinfectants are added to the water to be treated, permeated water produced during a period while chemicals are being added or after the addition, when chemicals may still remain, is drained and not used as production water, depending on the use of the treated water. However, this method has a problem in that it is impossible to produce water by the reverse osmosis treatment with the membrane unit while cleaning, which reduces the operating ratio and thus the amount of water production.

In particular, in multiple-stage reverse osmosis treatment apparatuses as described in Patent Document 1, bio-fouling is more noticeable in the reverse osmosis membrane modules at the front stage in the case of performing the reverse osmosis treatment on water to be treated in which microorganisms are likely to grow, such as seawater and sewage treatment water. For this reason, cleaning of the reverse osmosis membrane modules is carried out often when criteria for cleaning as the entire system are met due to contamination of membranes at the front stage. However, while the reverse osmosis membrane modules at the front stage is being cleaned, the reverse osmosis membrane modules at the rear stage cannot be operated as in the ordinary operation, so that operation of one of the multiple membrane units is stopped to clean it, and the remaining membrane units are operated at a higher water production rate than in the ordinary operation. Alternatively, as a necessary measure, a backup reverse osmosis membrane module line to be used only during a cleaning period is provided from the beginning to cover the amount of water production, or a buffer tank is provided from the beginning and the system is operated at a higher water production rate than in the ordinary operation before and after cleaning to compensate for the amount of water reduced in cleaning.

However, for the approach in which the reverse osmosis membrane modules are operated at a higher water production rate than in the ordinary operation to cover the amount of water production, power cost for pumps or the like increases to keep a higher operation pressure. In addition, pump selection or the like suitable for the approach is necessary at the design stage of the reverse osmosis treatment equipment, which also increases the equipment cost. The approach of providing a backup reverse osmosis membrane module line based on the premise of periodic cleaning makes the equipment cost high. The approach of providing a buffer tank from the beginning has a problem that the occupied area increases depending on the capacity of the buffer tank, which leads to higher equipment cost. As described above, the approaches involving major design changes on the reverse osmosis treatment equipment result in low cost efficiency in the case where the frequency of cleaning can be lower than expected, or the case where the water quality has changed due to seasonal variation or the like so that microorganisms are unlikely to grow, or other similar cases.

In light of the above, an object of the present invention is to provide a reverse osmosis treatment apparatus and a reverse osmosis treatment method capable of keeping high the amount of water production, even while the reverse osmosis membrane modules are being cleaned, by performing the reverse osmosis treatment using the remaining reverse osmosis membrane modules.

To solve the above problems, a reverse osmosis treatment apparatus according to the present invention includes a membrane unit including one or more reverse osmosis membrane modules to perform reverse osmosis treatment on water to be treated. The membrane unit includes a plurality of banks connected in series, each bank including the one or more reverse osmosis membrane modules disposed in parallel. At least one of the banks includes a treatment water pipe for supplying the water to be treated to the bank, a concentrated water pipe for discharging concentrated water separated by the bank from the bank, a treatment water pipe valve capable of closing the treatment water pipe, and a concentrated water pipe valve capable of closing the concentrated water pipe. A bypass pipe is connected between an upstream side of the treatment water pipe valve and a downstream side of the concentrated water pipe valve, the bypass pipe being capable of diverting the water to be treated, which is to be supplied to the bank, around the bank and draining the water to be treated. A chemical cleaning pipe is connected between a downstream side of the treatment water pipe valve and an upstream side of the concentrated water pipe valve, the chemical cleaning pipe being capable of supplying the reverse osmosis membrane modules disposed in the bank with chemical cleaning water for cleaning the reverse osmosis membrane modules.

A reverse osmosis treatment method uses a reverse osmosis treatment apparatus including a membrane unit including one or more reverse osmosis membrane modules to perform reverse osmosis treatment on water to be treated, in which the membrane unit includes a plurality of banks connected in series, each bank including the one or more reverse osmosis membrane modules disposed in parallel, at least one of the banks includes a treatment water pipe for supplying the water to be treated to the bank, a concentrated water pipe for discharging concentrated water separated by the bank from the bank, a treatment water pipe valve capable of closing the treatment water pipe, and a concentrated water pipe valve capable of closing the concentrated water pipe, a bypass pipe is connected between an upstream side of the treatment water pipe valve and a downstream side of the concentrated water pipe valve, the bypass pipe being capable of diverting the water to be treated, which is to be supplied to the bank, around the bank and draining the water to be treated, a chemical cleaning pipe is connected between a downstream side of the treatment water pipe valve and an upstream side of the concentrated water pipe valve, the chemical cleaning pipe being capable of supplying the reverse osmosis membrane modules disposed in the bank with chemical cleaning water for cleaning the reverse osmosis membrane modules. The reverse osmosis treatment method includes: performing the reverse osmosis treatment on the water to be treated using the banks; while performing the reverse osmosis treatment on the water to be treated, closing the treatment water pipe valve and the concentrated water pipe valve of one bank of the banks, diverting the water to be treated, which is to be supplied to the one bank, around the one bank and draining the water to be treated, and performing the reverse osmosis treatment on the water to be treated using a remaining bank of the banks; while performing the reverse osmosis treatment on the water to be treated using the remaining bank of the banks, supplying the chemical cleaning water to the one bank to clean the reverse osmosis membrane modules; and cleaning intermittently the one bank having the treatment water pipe valve and the concentrated water pipe valve, of the banks while continuing the reverse osmosis treatment.

The present invention provides a reverse osmosis treatment apparatus and a reverse osmosis treatment method capable of keeping high the amount of water production, even while the reverse osmosis membrane modules are being cleaned, by performing the reverse osmosis treatment using the remaining reverse osmosis membrane modules.

### BRIEF DESCRIPTION OF THE DRAWINGS

FIG. 1 is a diagram illustrating a configuration example of a reverse osmosis treatment apparatus according to an embodiment of the present invention;

FIG. 2 is a cross-sectional view illustrating an example of the structure of a reverse osmosis membrane module;

FIG. 3 is a perspective view illustrating an example of the structure of a reverse osmosis membrane element;

FIG. 4A is a diagram illustrating an example of the configuration of a chemical cleaning apparatus;

FIG. 4B is a diagram illustrating an example of the configuration of a chemical cleaning apparatus;

FIG. 5 is a diagram illustrating a configuration example of a reverse osmosis treatment apparatus according to an embodiment of the present invention;

FIG. 6 is a diagram illustrating a configuration example of a reverse osmosis treatment apparatus according to an embodiment of the present invention;

FIG. 7 is a diagram illustrating the configuration of a reverse osmosis treatment apparatus according to a first modification of the present invention;

FIG. 8 is a diagram illustrating the configuration of a reverse osmosis treatment apparatus according to a second modification of the present invention;

FIG. 9 is a diagram illustrating the configuration of a reverse osmosis treatment apparatus according to a third modification of the present invention; and

FIG. 10 is a diagram illustrating the configuration of a reverse osmosis treatment apparatus according to a fourth modification of the present invention.

### DETAILED DESCRIPTION OF THE EMBODIMENTS

Hereinafter, descriptions will be provided for a reverse osmosis treatment apparatus and a reverse osmosis treatment method according to an embodiment of the present invention. Note that common constituents in the drawings below are denoted by the same reference signs, and repetitive descriptions thereof are omitted.

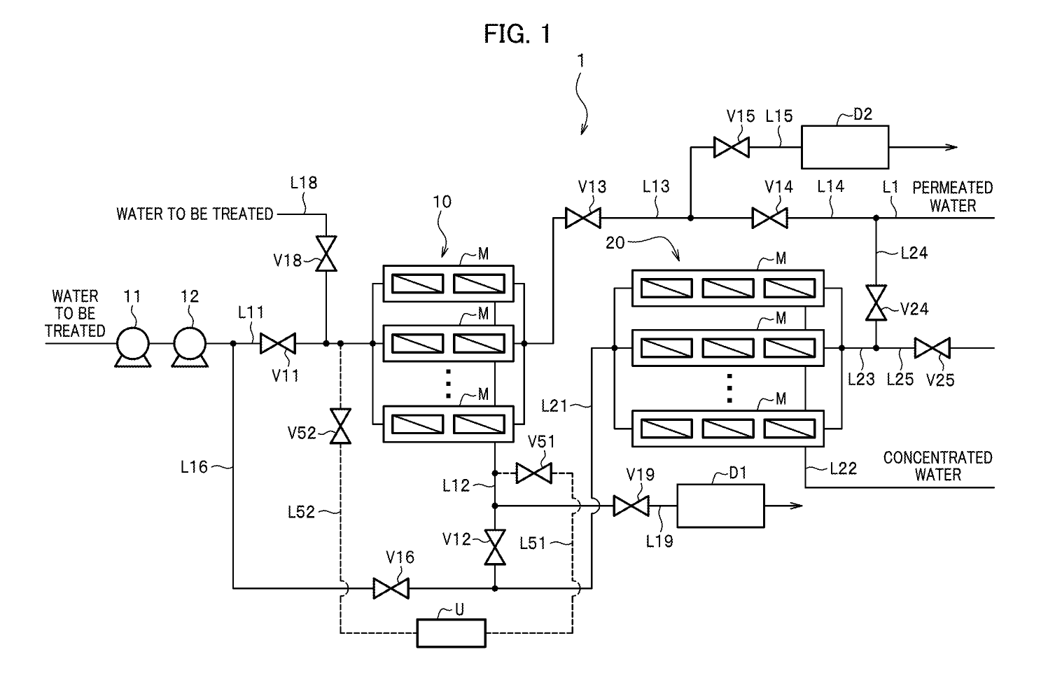

FIG. 1 is a diagram illustrating a configuration example of a reverse osmosis treatment apparatus according to an embodiment of the present invention.

As illustrated in FIG. 1, a reverse osmosis treatment apparatus 1 according to the present embodiment mainly includes multiple banks (10, 20), treatment water pipes (L11, L21), concentrated water pipes (L12, L22), permeated water pipes (L13, L23), a treatment water pipe valve (V11), a concentrated water pipe valve (V12), a permeated water pipe valve (V14), a bypass pipe (L16), and chemical cleaning pipes (L51, L52).

The banks (10, 20), each including reverse osmosis membrane modules M, form a membrane unit for reverse osmosis treatment of water to be treated. The multiple banks (10, 20) are connected in series via pipes. Note that FIG. 1 illustrates an example where the multiple banks (10, 20) are constituted of two stages: a first bank 10 and a second bank 20.

The reverse osmosis treatment apparatus 1 desalinates water to be treated by reverse osmosis and produces desalinated water with less concentration of ions and salts. As the water to be treated, saltwater such as seawater, produced water, brackish water, fossil water, groundwater, and surface water is supplied to the apparatus. The reverse osmosis treatment apparatus 1 can be used, for example, for applications such as desalination of seawater, reuse of drainage, and production of pure water.

The reverse osmosis treatment apparatus 1 according to the present embodiment has a feature that when cleaning is carried out by running chemical cleaning water through one bank (10, 20) of the multiple banks (10, 20) connected in series, the reverse osmosis treatment can be continued using the remaining bank (10, 20). Here, the structure of a reverse osmosis membrane module M included in the banks (10, 20) will be described.

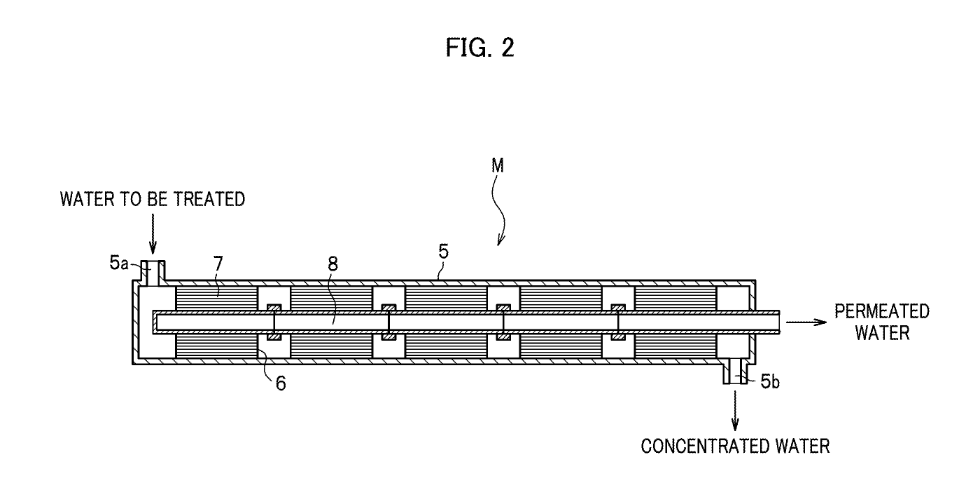

FIG. 2 is a cross-sectional view illustrating an example of the structure of the reverse osmosis membrane module.

As illustrated in FIG. 2, the reverse osmosis membrane module M includes a pressure vessel 5 and reverse osmosis membrane elements 6. The pressure vessel 5 is a vessel in a substantially cylindrical shape and has an introduction port 5a at one end and a delivering port 5b at the other end. The pressure vessel 5 houses one or more reverse osmosis membrane elements 6 therein. The reverse osmosis membrane element 6, including reverse osmosis membranes 7, are disposed in series inside the pressure vessel 5. Note that although the number of disposed reverse osmosis membrane elements 6 is five in total in FIG. 2, the number of reverse osmosis membrane elements 6 may be determined as appropriate depending on the specification of the reverse osmosis membrane module, the concentration rate of the reverse osmosis treatment, and other factors.

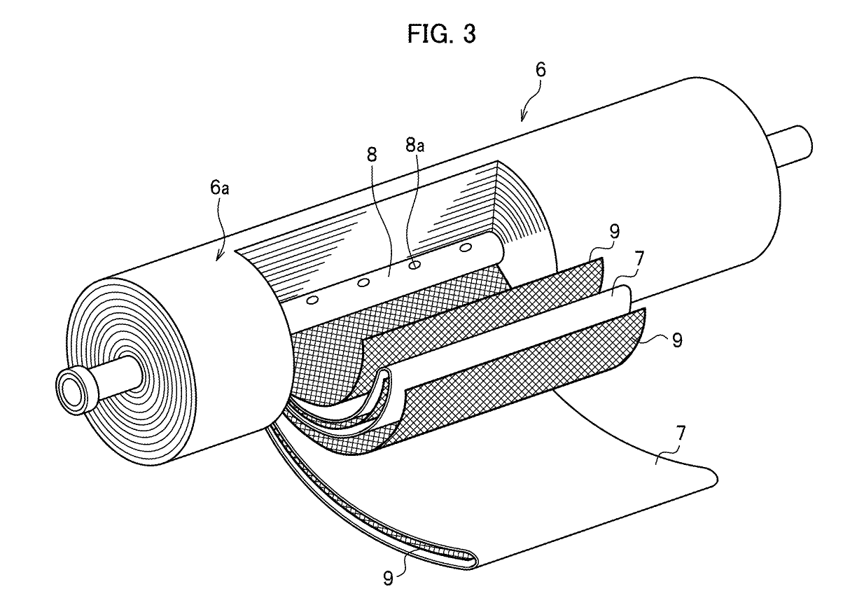

FIG. 3 is a perspective view illustrating an example of the structure of the reverse osmosis membrane element.

As illustrated in FIG. 3, the reverse osmosis membrane element 6 includes a water collection pipe 8 and membrane laminates 6a formed of stacked reverse osmosis membranes 7 and surrounding the water collection pipe 8. The membrane laminate 6a is formed of multiple reverse osmosis membranes 7 in a bag-like shape and spacers 9 in a mesh-like shape, which are joined radially on the circumferential surface of the water collection pipe 8 and wound in a spiral shape around the water collection pipe 8. The reverse osmosis membrane 7 is joined to the water collection pipe 8 such that the inside of the bag communicates with through holes 8a of the water collection pipe 8. The shape of the reverse osmosis membrane 7 is kept by the spacer 9 being interposed inside the bag and between adjacent reverse osmosis membranes 7.

As illustrated in FIG. 2, the reverse osmosis membrane elements 6 are housed in the pressure vessel 5 such that the water collection pipes 8 are oriented along the longitudinal direction of the pressure vessel 5 and disposed in series. The water collection pipes 8 of the reverse osmosis membrane elements 6, being connected to one another, form a single conduit with an open distal end, and the distal end of the water collection pipes 8 is drawn out from the end of the pressure vessel 5, the end being provided with the delivering port 5b.

In the reverse osmosis membrane module M illustrated in FIG. 2, water to be treated pressurized at the osmotic pressure or more is introduced into the pressure vessel 5 through the introduction port 5a. Then, while the water to be treated is flowing inside the pressure vessel 5 along the longitudinal direction, the reverse osmosis treatment is performed with the reverse osmosis membranes 7 by the cross flow filtration method. After that, concentrated water concentrated on the upstream sides of the reverse osmosis membranes 7 by the reverse osmosis treatment is discharged from the pressure vessel 5 through the delivering port 5b. On the other hand, permeated water which permeates the reverse osmosis membranes 7 to the downstream sides is collected inside the water collection pipes 8 and discharged from the distal end thereof.

In the banks (10, 20) illustrated in FIG. 1, the reverse osmosis membrane modules M described above are connected in parallel via pipes. The bank is usually composed of reverse osmosis membrane modules M having the same specification. Note that although the first bank 10 and the second bank 20 are composed of the multiple reverse osmosis membrane modules M disposed in parallel in FIG. 1, the number of the reverse osmosis membrane modules M may be one or any number of two or more.

As illustrated in FIG. 1, the multiple banks (10, 20) connected in series have the treatment water pipes (L11, L21) for supplying the water to be treated to the banks (10, 20); the concentrated water pipes (L12, L22) for discharging the concentrated water separated by the banks (10, 20), from the banks (10, 20); the permeated water pipes (L13, L23) for discharging the permeated water separated by the banks (10, 20), from the banks (10, 20), respectively.

In FIG. 1, provided as the treatment water pipes (L11, L21) are the first treatment water pipe L11 connected to the first bank 10 and the second treatment water pipe L21 connected to the second bank 20. Provided as the concentrated water pipes (L12, L22) are the first concentrated water pipe L12 connected to the first bank 10 and the second concentrated water pipe L22 connected to the second bank 20. Provided as the permeated water pipes (L13, L23) are the first permeated water pipe L13 connected to the first bank 10 and the second permeated water pipe L23 connected to the second bank 20.

The first treatment water pipe L11 forms a flow path in which the water to be treated can flow from a supply pump 11 disposed upstream of the first bank 10 through a high-pressure pump 12 toward the inlets (introduction ports 5a) on the upstream side of the reverse osmosis membrane modules M included in the first bank 10. The first treatment water pipe L11 is a pipe used for running to the first bank 10 the water to be treated which is to be subjected to the reverse osmosis treatment at the first bank 10. Disposed upstream of the first treatment water pipe L11 are the supply pump 11 for supplying the water to be treated which is to be subjected to the reverse osmosis treatment, from the outside of the system, and the high-pressure pump 12 for pressurizing the water to be treated to the osmotic pressure or more, and causing the water to be treated to permeate, by reverse osmosis, the reverse osmosis membranes included in the reverse osmosis membrane modules M.

The second treatment water pipe L21 forms a flow path in which water to be treated, which is the concentrated water separated on the front stage side, can flow from the first bank 10 disposed upstream of the second bank 20 toward the inlets (introduction ports 5a) on the upstream side of the reverse osmosis membrane modules M included in the second bank 20. The second treatment water pipe L21 is a pipe used for running to the second bank 20 the water to be treated which is to be subjected to the reverse osmosis treatment at the second bank 20.

The first concentrated water pipe L12 forms a flow path in which the concentrated water separated at the first bank 10 can flow from the outlets (delivering ports 5b) on the upstream side of the reverse osmosis membrane modules M included in the first bank 10, toward the inlets (introduction ports 5a) on the upstream side of the reverse osmosis membrane modules M included in the second bank 20. The first concentrated water pipe L12 is a pipe used for running to the second bank 20 the concentrated water separated at the first bank 10.

The second concentrated water pipe L22 forms a flow path in which the concentrated water separated at the second bank 20 can flow from the outlets (delivering ports 5b) on the upstream side of the reverse osmosis membrane modules M included in the second bank 20, toward the outside of the membrane unit system. The second concentrated water pipe L22 is a pipe used for discharging from the second bank 20 the concentrated water separated at the second bank 20.

The first permeated water pipe L13 forms a flow path in which the permeated water separated at the first bank 10 can flow from the outlets (the distal ends of the water collection pipes 8) on the downstream side of the reverse osmosis membrane modules M included in the first bank 10, toward the outside of the membrane unit system. The first permeated water pipe L13 is a pipe used for recovering the permeated water separated at the first bank 10. Note that in FIG. 1, connected downstream of the first permeated water pipe L13 are a first confluence pipe L14, first dividing pipe L15, and production water pipe L1.

The second permeated water pipe L23 forms a flow path in which the permeated water separated at the second bank 20 can flow from the outlets (the distal ends of the water collection pipes 8) on the downstream side of the reverse osmosis membrane modules M included in the second bank 20, toward the outside of the membrane unit system. The second permeated water pipe L23 is a pipe used for recovering the permeated water separated at the second bank 20. Note that in FIG. 1, connected downstream of the second permeated water pipe L23 are a second confluence pipe L24, the production water pipe L1, and a second dividing pipe L25.

The reverse osmosis treatment apparatus 1 is a multiple-stage reverse osmosis treatment apparatus including multiple banks (10, 20) connected in series. In the reverse osmosis treatment apparatus 1 including the two stages: the first bank 10 and the second bank 20, the first bank 10 disposed at the foremost state primarily treats the water to be treated by reverse osmosis. The water to be treated subjected to the reverse osmosis treatment at the first bank 10 is separated into first permeated water and first concentrated water. Then, the second bank 20 at the next stage secondarily treats by reverse osmosis the first concentrated water separated by the first bank 10. The water to be treated, which is the first concentrated water, subjected to the reverse osmosis treatment at the second bank 20 are separated into second permeated water and second concentrated water. Accordingly, the reverse osmosis treatment apparatus 1 is capable of producing desalinated water in the sum total of the amounts of water produced by both first bank 10 and second bank 20.

As illustrated in FIG. 1, in the reverse osmosis treatment apparatus 1 according to the present embodiment, the multiple banks (10, 20) connected in series have the treatment water pipe valve (V11) capable of stopping the flow of the water to be treated in the treatment water pipe (L11) and the concentrated water pipe valve (V12) capable of stopping the flow of the concentrated water in the concentrated water pipe (L12). In addition, the multiple banks (10, 20) have a flow rate adjustment valve V13 on the first permeated water pipe L13, and a first permeated water pipe valve V14 on the first confluence pipe L14, capable of stopping the flow of the permeated water in the first permeated water pipe L13 and the first confluence pipe L14.

The first bank 10 is configured such that the reverse osmosis treatment of the water to be treated is suspended by closing the inlet for the water to be treated with the treatment water pipe valve V11 and closing the outlet for the concentrated water with the concentrated water pipe valve V12.

In addition, for the bank (10), which is one of the multiple banks (10, 20) connected in series, the bypass pipe (L16) is connected between the treatment water pipe (L11) and the concentrated water pipe (L12).

The bypass pipe (L16) is a pipe for diverting the water to be treated, which is to be supplied to the bank (10), around the bank (10) and draining it. In FIG. 1, the bypass pipe L16 connects the upstream side of the treatment water pipe valve V11 on the treatment water pipe L11 and the downstream side of the concentrated water pipe valve V12 on the concentrated water pipe L12. Since the conduit formed by the bypass pipe L16 leads from the high-pressure pump 12 disposed upstream of the first bank 10 to the inlets (introduction ports 5a) on the upstream side of the reverse osmosis membrane modules included in the second bank 20, the water to be treated supplied for the reverse osmosis treatment can be supplied to the second bank 20 bypassing the first bank 10. Provided on the bypass pipe L16 is a bypass pipe valve V16 capable of closing the flow of the water to be treated in the bypass pipe L16.

In addition, for the bank (10), which is one of the multiple banks (10, 20) connected in series, the chemical cleaning pipes (L51, L52) are connected between the treatment water pipe (L11) and the concentrated water pipe (L12). In FIG. 1, provided as the chemical cleaning pipes (L51, L52) are the first chemical cleaning pipe L51 connected to the concentrated water pipe L12 and the second chemical cleaning pipe L52 connected to the treatment water pipe L11. Disposed on the first chemical cleaning pipe L51 is a first chemical cleaning pipe valve V51 capable of stopping the flow of chemical cleaning water in the first chemical cleaning pipe L51. Disposed on the second chemical cleaning pipe L52 is a second chemical cleaning pipe valve V52 capable of stopping the flow of the chemical cleaning water in the second chemical cleaning pipe L52.

The chemical cleaning pipes (L51, L52) are pipes for supplying the reverse osmosis membrane modules disposed in the bank (10) with the chemical cleaning water for cleaning the reverse osmosis membrane modules. In FIG. 1, the chemical cleaning pipes (L51, L52) connect the downstream side of the treatment water pipe valve V11 on the treatment water pipe L11 and the upstream side of the concentrated water pipe valve V12 on the concentrated water pipe L12. The other ends of the first chemical cleaning pipe L51 and the second chemical cleaning pipe L52 are connected to a common chemical cleaning apparatus U.

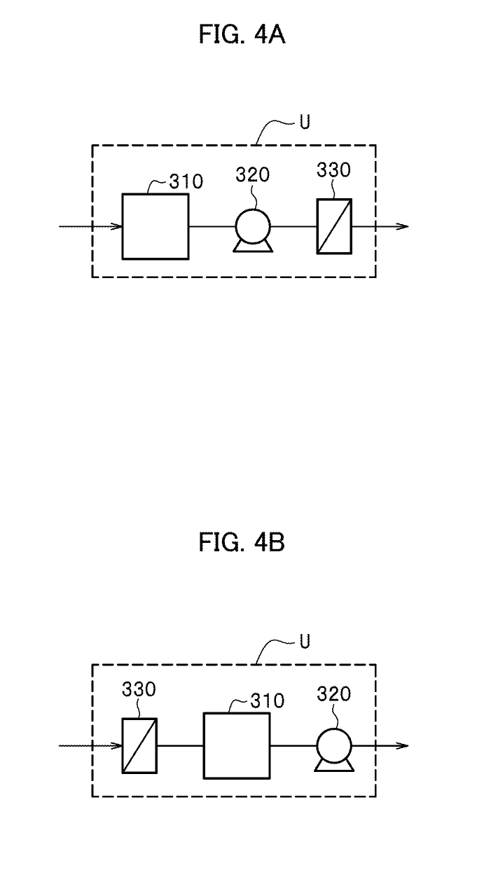

FIGS. 4A and 4B are diagrams each illustrating an example of the configuration of the chemical cleaning apparatus.

As illustrated in FIGS. 4A and 4B, the chemical cleaning apparatus U may include a chemical cleaning water tank 310 for temporarily storing the chemical cleaning water, a chemical cleaning pump 320 for passing the chemical cleaning water through the reverse osmosis membrane modules disposed in the bank (10), and a filter 330 for filtering out pollutants from the chemical cleaning water after cleaning.

The chemical cleaning apparatus U, including the chemical cleaning water tank 310, the chemical cleaning pump 320, the filter 330, and the like connected in series via pipes for the chemical cleaning water to flow through, is connected to the first chemical cleaning pipe L51 at one end and the second chemical cleaning pipe L52 at the other end. In other words, a circulation path in which the chemical cleaning water can circulate is formed between the chemical cleaning apparatus U and the bank (10). The chemical cleaning apparatus U is capable of carrying out in-situ cleaning of the insides of the reverse osmosis membrane modules disposed in the bank (10) with the chemical cleaning water by running the chemical cleaning water in the circulation path.

Examples of the chemical cleaning water that can be used include: oxidizing chemical agents, such as compounds containing sodium hypochlorite, chloramine, and bound bromine; disinfectants, such as 2,2-dibromo-3-nitrilopropionamide (DBNPA); chelating agents, such as ethylenediaminetetraacetic acid (EDTA); and chemical solutions containing an acid, alkali, surfactant, or the like. A chemical solution obtained by dissolving the one or morese in water can be used as the chemical cleaning water. The in-situ cleaning with the chemical cleaning apparatus U is carried out, for example, by combining various processes such as flushing in which clear water is passed through unidirectionally and drained; flushing using the chemical cleaning water; circulation of the chemical cleaning water on the circulation path; immersion in which the inside of the reverse osmosis membrane module is filled with chemical cleaning water and left still; and immersion in which the inside of the reverse osmosis membrane module is filled with clear water and left still.

The chemical cleaning apparatus U may run the chemical cleaning water from the first concentrated water pipe L12 side via the first chemical cleaning pipe L51, or may run the chemical cleaning water from the first treatment water pipe L11 side via the second chemical cleaning pipe L52. When the chemical cleaning water is run from the first concentrated water pipe L12 side, each of the reverse osmosis membrane modules disposed in the bank (10) is backwashed with the chemical cleaning water from the outlet (delivering port 5b) on the upstream side. Microbial membranes or the like firmly adhering in the direction of the flow of the water to be treated are easily peeled off by the chemical cleaning water flowing in the reverse direction, and thus it is possible to carry out the cleaning effectively.

As illustrated in FIG. 4A, the chemical cleaning apparatus U may include the chemical cleaning water tank 310, chemical cleaning pump 320, and filter 330 in this order along the flowing direction of the chemical cleaning water. In the case of the order illustrated in FIG. 4A, reactants produced by chemicals put into the chemical cleaning water tank 310, foreign matter which has entered the chemical cleaning water tank 310, and the like are removed by the filter 330 before they flow into the reverse osmosis membrane modules disposed in the bank (10). Accordingly, it is possible to prevent these reactants, foreign matter, and the like from flowing into the reverse osmosis membrane modules and adhering to the flow paths inside the reverse osmosis membrane modules.

Alternatively, as illustrated in FIG. 4B, the chemical cleaning apparatus U may include the filter 330, the chemical cleaning water tank 310, and the chemical cleaning pump 320 in this order along the flowing direction of the chemical cleaning water. In the case of the order illustrated in FIG. 4B, pollutants remaining in the chemical cleaning water returned from the bank (10) are removed by the filter 330 before they flow into the chemical cleaning water tank 310. Accordingly, it is possible to prevent the pollutants from reacting with the chemicals put into the chemical cleaning water tank 310 and weakening the effect of the chemicals. It is also possible to prevent the pollutants from flowing again into the reverse osmosis membrane modules and adhering to the flow paths.

As illustrated in FIG. 1, for the bank (10), which is one of the multiple banks (10, 20) connected in series, the treatment water pipe (L11) is connected to a water supply pipe (L18), and the concentrated water pipe (L12) to a water drain pipe (L19).

The water supply pipe (L18) is a pipe for supplying the water to be treated to the reverse osmosis membrane modules disposed in the bank (10). In FIG. 1, the water supply pipe L18 is connected to a portion on the treatment water pipe L11, between the treatment water pipe valve V11 and the first bank 10. Disposed on the water supply pipe L18 is a water supply pipe valve V18 capable of stopping the flow of the water to be treated in the water supply pipe L18. The liquid inside the reverse osmosis membrane modules can be replaced with the water to be treated supplied through the water supply pipe L18. As alternative structures, for example, the water supply pipe L18 may branch off from the upstream side of the high-pressure pump 12 and be connected to an intermediate portion of the treatment water pipe L11, or may be branch off from the downstream side of the high-pressure pump 12 and be connected to an intermediate portion of the treatment water pipe L11, on the supply path for supplying the water to be treated toward the first bank 10.

The water drain pipe (L19) is a pipe for draining the concentrated water separated by the reverse osmosis treatment, the chemical cleaning water supplied to the bank (10), the water to be treated, or the like, from the bank (10) to the outside of the system. In FIG. 1, the water drain pipe L19 is connected to a portion on the concentrated water pipe L12, between the concentrated water pipe valve V12 and the first bank 10. Disposed on the water drain pipe L19 are a water drain pipe valve V19 capable of stopping the flow in the water drain pipe L19, and a liquid detector D1.

The liquid detector D1 includes a detector capable of detecting properties of liquid such as pH and electrical conductivity. The liquid detector D1 measures pH, electrical conductivity, and the like, and an appropriate instrument that can detect liquid inside the reverse osmosis membrane modules from the composition of liquid may be used, such as hydrogen electrodes, glass electrodes, various pH meters equipped with semiconductor sensors, and various electrical conductivity meters of an AC type, an electromagnetic induction type, or other types.

As illustrated in FIG. 1, the bank (10) having the treatment water pipe valve (V11) and the concentrated water pipe valve (V12) is connected to a liquid detector D2 via the first permeated water pipe L13 and other devices. The first permeated water pipe L13 is connected to the first bank 10 at one end, and the other end thereof branches into the first confluence pipe L14 and the first dividing pipe L15. Disposed on the first confluence pipe L14 is the first permeated water pipe valve V14, and disposed on the first dividing pipe L15 is a first dividing pipe valve V15 capable of stopping the flow of the permeated water in the first dividing pipe L15. Then, connected to the downstream side of the first confluence pipe L14 is the production water pipe L1, and connected to the downstream side of the first dividing pipe valve V15 on the first dividing pipe L15 is the liquid detector D2. The liquid detector D2 includes a detector capable of detecting properties of liquid such as pH and electrical conductivity, like the liquid detector D1.

As illustrated in FIG. 1, one end of the second permeated water pipe L23 is connected to the second bank 20, and the other end thereof branches into the second confluence pipe L24 and the second dividing pipe L25. Disposed on the second confluence pipe L24 is a second permeated water pipe valve V24 capable of stopping the flow of the permeated water in the second permeated water pipe L23 and the second confluence pipe L24, and disposed on the second dividing pipe L25 is a second dividing pipe valve V25 capable of stopping the flow of the permeated water in the second dividing pipe L25. Then, the first confluence pipe L14 merges into the downstream side of the second confluence pipe L24, and both are connected to the production water pipe L1.

The first permeated water separated at the first bank 10 is drained individually toward the outside of the system through the first confluence pipe L14 and the production water pipe L1, is discharged after joining the second permeated water separated at the second bank 20, or is introduced into the liquid detector D2 through the first dividing pipe L15. The second permeated water separated in the second bank 20 is drained individually toward the outside of the system through the second confluence pipe L24 and the production water pipe L1, is discharged after joining the first permeated water separated in the first bank 10, or is drained through the second dividing pipe L25.

Note that in the reverse osmosis treatment apparatus 1, the water supply pipe (L18), water drain pipe (L19), liquid detector D1, and liquid detector D2 do not necessarily need to be included. Alternatively, it is possible to manually analyze sample liquid instead of using the liquid detector D1 and the liquid detector D2.

Next, descriptions will be provided for a reverse osmosis treatment method using the reverse osmosis treatment apparatus 1.

The reverse osmosis treatment apparatus 1 illustrated in FIG. 1, typically, performs the reverse osmosis treatment on the water to be treated using the multiple banks (10, 20) connected in series. The reverse osmosis membranes included in the reverse osmosis membrane module are contaminated with organic substances contained in the water to be treated, microorganisms growing on the membrane surfaces, inorganic substances precipitated as scales, and the like, during the reverse osmosis treatment of the water to be treated, which can cause blocking, but stopping the operation of the apparatus decreases the amount of water production. For this reason, in the reverse osmosis treatment apparatus 1, cleaning of the reverse osmosis membrane modules disposed in the bank (10) is carried out without suspending the reverse osmosis treatment.

Cleaning of the reverse osmosis membrane modules can be carried out while the reverse osmosis treatment apparatus 1 is being operated. For example, when the operation time of the reverse osmosis membrane modules reaches a predetermined time, when the transmembrane pressure difference of the reverse osmosis membrane modules exceeds a predetermined value, or when the pressure drop of a flow path of the bank (10) exceeds a predetermined value, it is possible to switch valves and flow paths to clean the reverse osmosis membrane modules disposed in the bank (10). Cleaning of the reverse osmosis membrane modules disposed in the bank (10) can be repeated intermittently during operation of the reverse osmosis treatment apparatus 1.

The following Table 1 illustrates an example of open-closed states of the valves at the time when the reverse osmosis membrane modules disposed in the bank (10), which is one of the multiple banks (10, 20), are cleaned. For cleaning of the reverse osmosis membrane modules, as illustrated in Table 1, it is preferable to carry out in this order, a normal operation for performing the reverse osmosis treatment on the water to be treated using the multiple banks (10, 20) connected in series, a cleaning operation for cleaning the reverse osmosis membrane modules, and a first return operation and a second return operation for returning the reverse osmosis membrane modules to the state ready for operation.

TABLE 1

| | | | First | Second |
|---|---|---|---|---|
| | Normal | Cleaning | return | return |
| Process | operation | operation | operation | operation |
| Treatment water pipe | open | closed | closed | open |
| valve (V11) | | | | |
| Concentrated water pipe | open | closed | closed | open |
| valve (V12) | | | | |
| First permeated water | open | closed | closed | closed |
| pipe valve (V14) | | | | |
| First dividing pipe valve | closed | closed | closed | open |
| (V15) | | | | |
| Bypass pipe valve (V16) | closed | open | open | closed |
| Second permeated water | open | open | open | open |
| pipe valve (V24) | | | | |
| Second dividing pipe | closed | closed | closed | closed |
| valve (V25) | | | | |
| First chemical cleaning | closed | open | closed | closed |
| pipe valve (V51) | | | | |
| Second chemical cleaning | closed | open | closed | closed |
| pipe valve (V52) | | | | |
| Water supply pipe valve | closed | closed | open | closed |
| (V18) | | | | |
| Water drain pipe valve | closed | closed | open | closed |
| (V19) | | | | |

As illustrated in Table 1, in the normal operation, the treatment water pipe valve (V11) and the concentrated water pipe valve (V12) are open, and the bypass pipe valve V16 is closed. In addition, the first permeated water pipe valve V14 and the second permeated water pipe valve V24 are open, and the first dividing pipe valve V15, second dividing pipe valve V25, first chemical cleaning pipe valve V51, second chemical cleaning pipe valve V52, water supply pipe valve V18, and water drainpipe valve V19 are closed. The first bank 10 and the second bank 20 perform the reverse osmosis treatment on the water to be treated, and the permeated water separated in this process is drained toward the outside of the system through the production water pipe L1.

Next, in the cleaning operation, while the reverse osmosis treatment is being performed on the water to be treated, the treatment water pipe valve (V11) and the concentrated water pipe valve (V12) of the bank (10), which is one of the multiple banks (10, 20), are closed. In addition, all of the first permeated water pipe valve V14, first dividing pipe valve V15, and second dividing pipe valve V25 are closed. On the other hand, the bypass pipe valve (V16), second permeated water pipe valve V24, first chemical cleaning pipe valve V51, and second chemical cleaning pipe valve V52 are opened. Then, the water to be treated which is to be supplied to the bank (10), the valve for which is now closed, is diverted around the bank (10) via the bypass pipe (L16), and the reverse osmosis treatment is continued using the remaining bank (20) of the multiple banks (10, 20). While the reverse osmosis treatment is being performed on the water to be treated using the remaining bank (20), the chemical cleaning water is passed through the bank (10), the valve for which is closed, via the chemical cleaning pipes (L51, L52) to clean the reverse osmosis membrane modules.

During the cleaning operation, at least one of the outputs of the supply pump 11 and the high-pressure pump 12 is controlled to adjust the amount of water production of the permeated water. It is preferable that the flow rate of the permeated water of the remaining bank (20) in cleaning the bank (10), which is one of the banks, be set larger than or equal to the flow rate of the permeated water of the remaining bank (20) at the time of the normal operation. This setting minimizes the decrease by the cleaning in the amount of water production. In addition, it is preferable that the total flow rate of the permeated water as all the multiple banks (10, 20) at the time of cleaning the bank (10), which is one of the banks, be set smaller than or equal to the total flow rate of the permeated water as all the multiple banks (10, 20) at the time of the normal operation. With this setting, an increase in the load to the reverse osmosis membranes at the time when the amount of water production by the remaining bank (20) is raised is suppressed. Accordingly, the reverse osmosis treatment can be continued more stably.

Next, in the first return operation, after the reverse osmosis membrane modules are cleaned, the first chemical cleaning pipe valve V51 and the second chemical cleaning pipe valve V52 are closed. On the other hand, the water supply pipe valve V18 and the water drain pipe valve V19 are opened. Then, through the water supply pipe L18, the water to be treated is supplied to the cleaned reverse osmosis membrane modules, and the liquid inside the reverse osmosis membrane modules is replaced with the water to be treated. The water to be treated supplied to the reverse osmosis membrane modules is drained together with the liquid remaining inside the reverse osmosis membrane modules, to the outside of the system through the water drain pipe L19. Carrying out the first return operation replaces the liquid inside the reverse osmosis membrane modules with the water to be treated. For that reason, it is possible to continue the water production by the reverse osmosis treatment without suspension, keeping the upper limit of the membrane flux on the specification of the reverse osmosis membrane module, while preventing a high pressure from being applied to the liquid inside the reverse osmosis membrane modules to prevent the flux from increasing suddenly.

Next, in the second return operation, the treatment water pipe valve (V11) and the concentrated water pipe valve (V12) of the bank (10) are opened, and the bypass pipe valve (V16) is closed. In addition, the water supply pipe valve V18 and the water drain pipe valve V19 are closed, and the first dividing pipe valve V15 is opened. Then, the permeated water separated at the bank (10) having the treatment water pipe valve (V11) and the concentrated water pipe valve (V12) is introduced into the liquid detector D2 through the first dividing pipe L15, and the water quality of the permeated water is detected. If the liquid detected by the liquid detector D2 is within the specification of the production water, the second return operation is terminated. The second return operation prevents permeated water, the water quality of which has not been checked, from being recovered from the production water pipe L1. In other words, the second return operation prevents an increase in the total dissolved solid in the permeated water by acid, contamination of the permeated water by disinfectants, or the like.

After that, the operation returns to the normal operation, some valves are switched, and the multiple-stage reverse osmosis treatment using the multiple banks (10, 20) is resumed. The reverse osmosis treatment continues while the bank (10) having the treatment water pipe valve (V11) and the concentrated water pipe valve (V12) is cleaned intermittently.

According to the reverse osmosis treatment apparatus 1 and the reverse osmosis treatment method described above, even at the time of cleaning of the reverse osmosis membrane modules, the reverse osmosis treatment can be continued without suspending the reverse osmosis treatment. Accordingly, it is possible to keep a high operating ratio of the reverse osmosis membrane module and keep the amount of water production as the entire apparatus high. Specifically, in conventional reverse osmosis treatment apparatuses, considering the amount of water production per membrane unit, the capacity of a spare system of the reverse osmosis membrane modules, a buffer tank, or the like need to be large. However, according to the reverse osmosis treatment apparatus 1 and the reverse osmosis treatment method described above, even at the time of cleaning the reverse osmosis membrane modules, a decrease exceeding the amount of water production per bank is unlikely to occur. Hence, the capacity of a spare system of the reverse osmosis membrane modules, a buffer tank, or the like does not need to be large, which reduces equipment cost. In addition, since it is not always necessary to keep a high operating pressure for compensating for the amount of water production decreased at the time of cleaning, no restriction is imposed on selection of the pumps, and the load of pressure applied to the reverse osmosis membranes can be reduced.

In particular, according to the reverse osmosis treatment apparatus 1, it is possible to clean the bank (10) at the front stage with the chemical cleaning water, diverting the water to be treated around the bank (10). Accordingly, it is possible to continuously prevent bio-fouling and contamination by scales in the reverse osmosis membrane modules disposed in the bank (10) at the front stage. Since, from experiences, contamination by organic substances and the like and bio-fouling are more noticeable in the bank (10) at the front stage, the reverse osmosis treatment apparatus 1 is suitable for the reverse osmosis treatment in the case where the water quality of the water to be treated is not good.

In addition, according to the reverse osmosis treatment method in which the normal operation, cleaning operation, first return operation, and second return operation are repeated, the reverse osmosis membrane modules cleaned by the chemical cleaning water flowing through can be returned to the reverse osmosis treatment without suspending supply of the water to be treated by the supply pump 11. Accordingly, it is possible to keep a higher operating ratio of the reverse osmosis membrane modules and increase the amount of water production as the entire apparatus. Note that in cleaning the reverse osmosis membrane modules, the first return operation and the second return operation may be eliminated. For example, it is possible to suspend operation of the apparatus temporarily and supply the water to be treated to the cleaned reverse osmosis membrane modules for replacement through the ordinary supply path in which the supply pump 11 is disposed.

Next, descriptions will be provided for other configuration examples of reverse osmosis treatment apparatuses according to embodiments of the present invention.

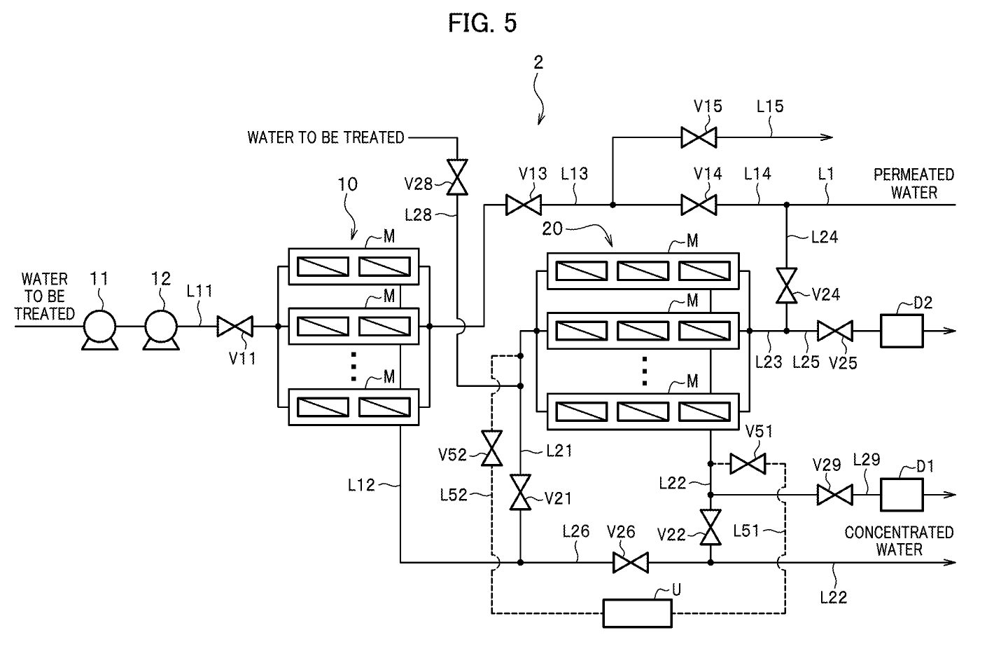

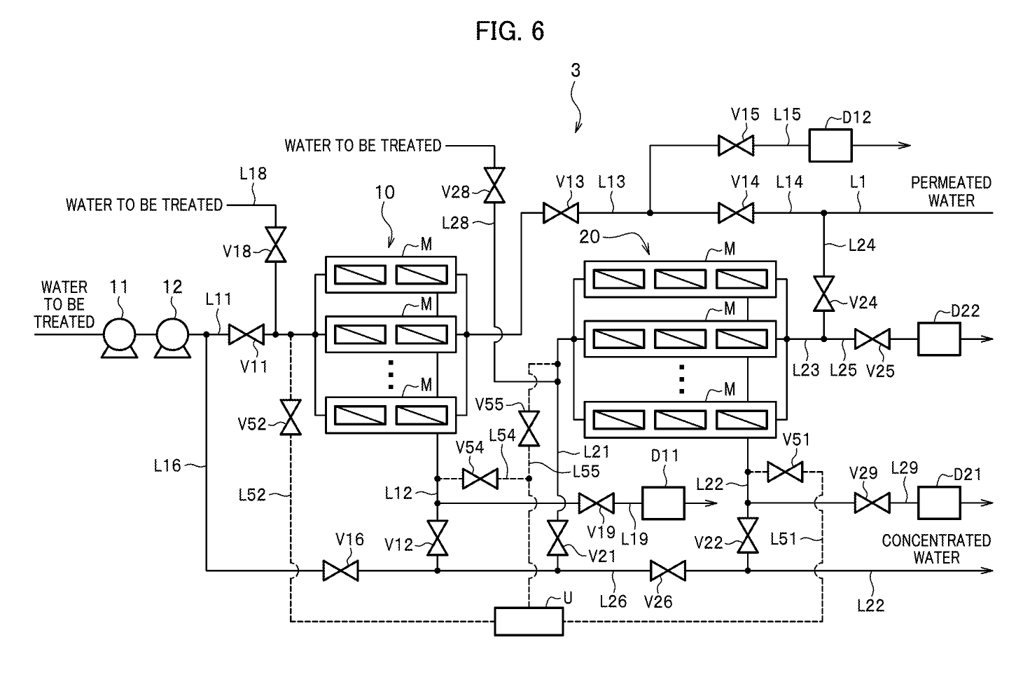

FIGS. 5 and 6 are diagrams illustrating configuration examples of reverse osmosis treatment apparatuses according to embodiments of the present invention.

In the foregoing reverse osmosis treatment apparatus 1, the bank (10) at the front stage of the multiple banks (10, 20) connected in series is cleaned with the chemical cleaning water, with the water to be treated diverted around the bank (10). However, as illustrated in FIGS. 5 and 6, of the multiple banks (10, 20) connected in series, a bank (10, 20) which is cleaned with the chemical cleaning water with the water to be treated diverted around may be the bank (20) at the rear stage, or may be multiple banks (10, 20). In other words, of the multiple banks (10, 20) connected in series, an arbitrary number of one or more of stages each have a treatment water pipe valve and a concentrated water pipe valve and may be connected to a bypass pipe and a chemical cleaning pipe.

In a reverse osmosis treatment apparatus 2 illustrated in FIG. 5, of the multiple banks (10, 20) connected in series, the bank (20) at the rear stage has the treatment water pipe (L21) and the concentrated water pipe (L22), as well as a treatment water pipe valve (V21) capable of stopping the flow of the water to be treated in the treatment water pipe (L21) and a concentrated water pipe valve (V22) capable of stopping the flow of the concentrated water in the concentrated water pipe (L22). In addition, connected to the treatment water pipe (L21) and the concentrated water pipe (L22) are a bypass pipe (L26) for diverting the water to be treated, which is to be supplied to the bank (20), around the bank (20) and draining it, and the chemical cleaning pipes (L51, L52) for supplying the reverse osmosis membrane modules disposed in the bank (20) with the chemical cleaning water to clean the reverse osmosis membrane modules.

In addition, in the reverse osmosis treatment apparatus 2, for the bank (20) at the rear stage of the multiple banks (10, 20) connected in series, a water supply pipe (L28) is connected to the treatment water pipe (L21), and a water drain pipe (L29) is connected to the concentrated water pipe (L22). Disposed to the water drain pipe L29 is the liquid detector D1. Connected to the second dividing pipe L25 is the liquid detector D2. The configurations and usage of the bypass pipe (L26), water supply pipe (L28), water drain pipe (L29), and liquid detectors (D1, D2) are the same as those of the foregoing ones connected to the first bank 10.

The reverse osmosis treatment apparatus 2 illustrated in FIG. 5 and the reverse osmosis treatment method using the same make it possible to divert the water to be treated around the bank (20) at the rear stage, and clean the bank (20) with the chemical cleaning water. Accordingly, it is possible to continuously prevent bio-fouling and contamination by scales in the reverse osmosis membrane modules disposed in the bank (20) at the rear stage. Fouling of scales is noticeable at the bank (20) at the rear stage because the concentration progresses, so that the reverse osmosis treatment apparatus 2 is suitable for the reverse osmosis treatment of the water to be treated containing inorganic substances such as ions and salts.

Meanwhile, in a reverse osmosis treatment apparatus 3 illustrated in FIG. 6, the multiple banks (10, 20) connected in series have the treatment water pipes (L11, L21) and the concentrated water pipes (L12, L22), as well as the treatment water pipe valves (V11, V21) capable of stopping the flow of the water to be treated in the treatment water pipes (L11, L21) and the concentrated water pipe valves (V12, V22) capable of stopping the flow of the concentrated water in the concentrated water pipes (L12, L22). In addition, the bypass pipes (L16, L26) and the chemical cleaning pipes (L51, L52, L54, L55) are connected to the treatment water pipes (L11, L21) and the concentrated water pipes (L12, L22).

In the reverse osmosis treatment apparatus 3, the chemical cleaning pipe L51 is connected to the concentrated water pipe L22 of the second bank 20. The chemical cleaning pipe L55 is connected to the treatment water pipe L21 of the second bank 20. The other ends of the chemical cleaning pipe L51 and the chemical cleaning pipe L55 are connected to a common chemical cleaning apparatus U, and a circulation path in which the chemical cleaning water can circulate is formed between the chemical cleaning apparatus U and the second bank 20. Meanwhile, the chemical cleaning pipe L52 is connected to the treatment water pipe L11 of the first bank 10. In addition, the chemical cleaning pipe L54 is connected to the concentrated water pipe L12 of the first bank 10. The other ends of the chemical cleaning pipe L52 and the chemical cleaning pipe L54 are connected to the common chemical cleaning apparatus U, and a circulation path in which the chemical cleaning water can circulate is formed between the chemical cleaning apparatus U and the first bank 10. Disposed on the chemical cleaning pipes (L51, L52, L54, L55) are chemical cleaning pipe valves (V51, V52, V54, V55), respectively, which are capable of stopping the flow of the chemical cleaning water.

In addition, in the reverse osmosis treatment apparatus 3, connected to the treatment water pipes (L11, L21) and the concentrated water pipes (L12, L22) of the multiple banks (10, 20) connected in series are the water supply pipes (L18, L28) and the water drain pipes (L19, L29), respectively. Disposed to the water drain pipe L19 connected to the first bank 10 is a liquid detector D11, and disposed to the water drain pipe L29 connected to the second bank 20 is a liquid detector D21. In addition, connected to the first dividing pipe L15 is a liquid detector D12, and connected to the second dividing pipe L25 is a liquid detector D22. The configurations and usage of the bypass pipe (L26), water supply pipe (L28), and water drain pipe (L29) are the same as those of the foregoing ones connected to the first bank 10. The configurations of the liquid detectors (D11, D12, D21, D22) are the same as that of the forgoing liquid detector D1.

The reverse osmosis treatment apparatus 3 is capable of diverting the water to be treated, which is to be supplied to one of the first bank 10 and the second bank 20 connected in series, around the bank and draining it while performing the reverse osmosis treatment using the remaining bank. Specifically, it is possible to divert the water to be treated, which is to be supplied to the first bank 10, around the first bank 10 to supply it to the second bank 20, and perform the reverse osmosis treatment on it at the second bank 20. It is also possible to perform the reverse osmosis treatment on the water to be treated at the first bank 10, and divert the water to be treated which is to be supplied to the second bank 20, in other words, the first concentrated water, around the second bank 20 to drain it.

Then, while the reverse osmosis treatment is being performed on the water to be treated, using the remaining bank of the first bank 10 and the second bank 20, the chemical cleaning water is supplied to the bank around which the water to be treated is diverted, and the reverse osmosis membrane modules are cleaned. In other words, only one of the circulation path at the front stage formed of the first bank 10, chemical cleaning pipe L52, and chemical cleaning pipe L54 and the circulation path at the rear stage formed of the second bank 20, chemical cleaning pipe L51, and chemical cleaning pipe L55 is used for passing the chemical cleaning water through, and in-situ cleaning is carried out with the chemical cleaning apparatus U, while the reverse osmosis treatment is being continued. Cleaning of the reverse osmosis membrane modules can be performed by carrying out the normal operation, cleaning operation, first return operation, and second return operation in this order in the same way as above.

According to the reverse osmosis treatment apparatus 3 illustrated in FIG. 6 and the reverse osmosis treatment method using the same, whichever of the multiple banks (10, 20) connected in series needs cleaning, it is possible to carry out cleaning with the chemical cleaning water by diverting the water to be treated without suspending the reverse osmosis treatment. Accordingly, for the reverse osmosis membrane modules disposed in any of the bank (10) at the front stage and the bank (20) at the rear stage, it is possible to continuously prevent bio-fouling and contamination by scales. In particular, in the case where the water quality of the water to be treated is not good, and the concentrations of both organic substances and inorganic substances are high, bio-fouling in the bank (10) at the front stage and fouling of scales in the bank (20) at the rear stage can become serious at different timings. For such water to be treated, since the reverse osmosis membrane modules disposed in both the bank (10) at the front stage and those in the bank (20) at the rear stage can be cleaned at mutually different timings, it is possible to prevent each contamination continuously while minimizing the decrease in the operating ratio.

Next, descriptions will be provided for the configurations of reverse osmosis treatment apparatuses (reverse osmosis treatment systems) according to modifications of the present invention.

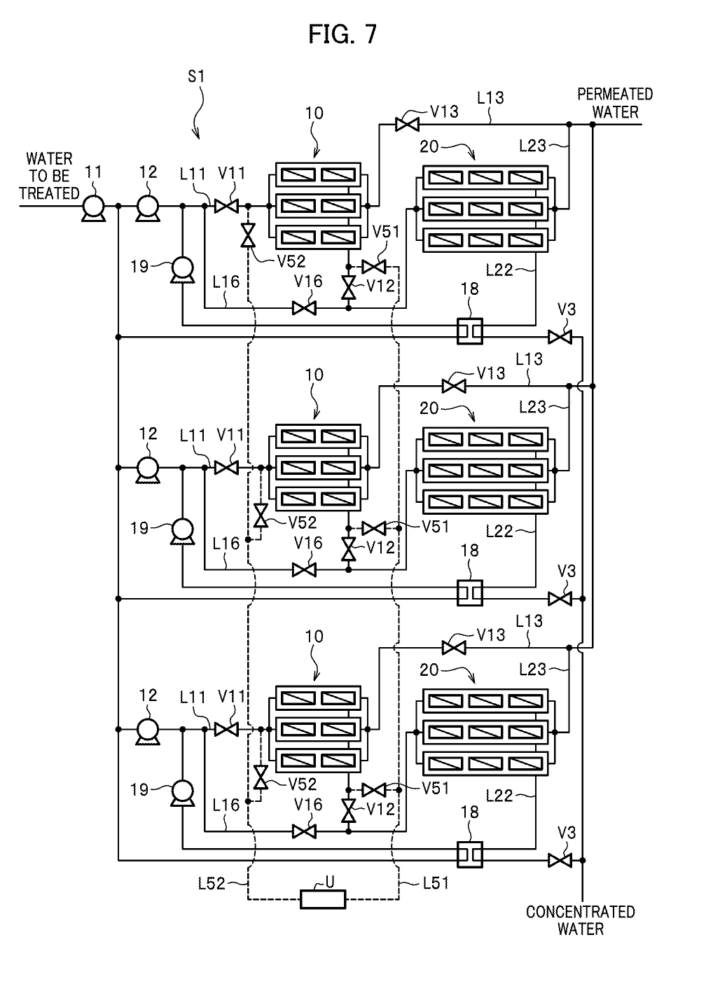

FIG. 7 is a diagram illustrating the configuration of a reverse osmosis treatment apparatus according to a first modification of the present invention.

As illustrated in FIG. 7, the foregoing reverse osmosis treatment apparatus (1, 2, 3) including the multiple-stage banks (10, 20) can form a membrane unit of a power recovery type, together with the supply pump (first pump) 11, the high-pressure pump (second pump) 12, a power recovery apparatus 18, and a booster pump (third pump) 19. By connecting such membrane units in parallel with each other via pipes at the downstream side of the supply pump 11, it is possible to form a reverse osmosis treatment system (reverse osmosis treatment apparatus according to the modification) S1 including membrane unit lines.

The power recovery apparatus 18 is an apparatus for increasing the pressure of the water to be treated to be supplied to the bank (10) at the front stage, utilizing the residual pressure of the concentrated water separated at the bank (20) at the rear stage. The power recovery apparatus 18, for example, includes a pressure exchanger of a pressure exchanger (PX) type, a dual work energy exchanger (DWEER) type, or the like; an energy exchanger of a turbocharger type; or an apparatus capable of exchanging energies such as pressure or flow speed, such as a Pelton water wheel.

The booster pump 19 is provided to pressurize the water to be treated the pressure of which has been increased by the power recovery apparatus 18. The booster pump 19 covers the pressure which has been increased by the power recovery apparatus 18 but is still deficient, and increases the pressure of the water to be treated to the osmotic pressure or more to pass it by reverse osmosis through the reverse osmosis membranes included in the reverse osmosis membrane modules.

The power recovery apparatus 18 and the booster pump 19 are disposed on a conduit branched off at a branch point upstream of the high-pressure pump 12 for each membrane unit including the multiple banks (10, 20). Each branched conduit, after passing from the power recovery apparatus 18 through the booster pump 19, joins to a confluence point downstream of the high-pressure pump 12 to form a flow path leading to the first bank 10.

In the reverse osmosis treatment system S1 illustrated in FIG. 7, the supply pump 11 is provided in common for the membrane unit lines and connected to each of the multiple membrane units disposed in parallel via pipes. On the other hand, the high-pressure pump 12, power recovery apparatus 18, and booster pump 19 are provided for each of the multiple membrane units connected in parallel. Disposed downstream of the power recovery apparatus 18 on the concentrated water pipe L22 is a flow rate adjustment valve V3. The flow rate adjustment valve V3 provides a back pressure and capable of adjusting the flow rate. In the reverse osmosis treatment system S1, the chemical cleaning apparatus U is provided in common for the membrane units lines.

In the reverse osmosis treatment system S1, it is possible to clean reverse osmosis membrane modules disposed in a bank (10) included in a membrane unit line of the membrane unit lines connected in parallel while continuing the reverse osmosis treatment using reverse osmosis membrane modules disposed in the remaining bank. For the membrane unit including the reverse osmosis membrane modules being cleaned, the flow rate of the water to be treated supplied for the reverse osmosis treatment is adjusted by the output of the high-pressure pump 12 provided for each membrane unit line.

According to the reverse osmosis treatment system (reverse osmosis treatment apparatus according to the modification) S1 and the reverse osmosis treatment method using the same, it is possible to supply the water to be treated to the membrane unit lines connected in parallel using the common supply pump 11. Accordingly, equipment cost can be reduced while a high amount of water production is kept. The supply pump 11 can be of a large type, which is advantageous to improve power efficiency.

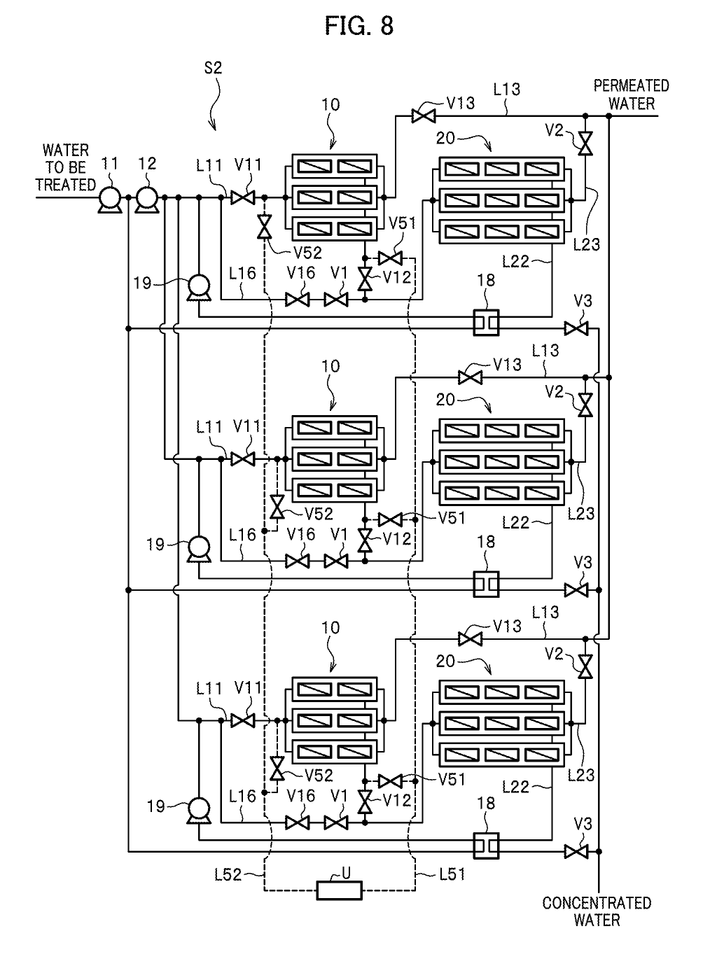

FIG. 8 is a diagram illustrating the configuration of a reverse osmosis treatment apparatus according to a second modification of the present invention.

As illustrated in FIG. 8, the foregoing reverse osmosis treatment apparatus (1, 2, 3) including the multiple-stage banks (10, 20) can form a membrane unit of a power recovery type, together with the supply pump (first pump) 11, high-pressure pump (second pump) 12, power recovery apparatus 18, and booster pump (third pump) 19. By connecting such membrane units in parallel with each other via pipes at the downstream side of the supply pump 11, it is possible to form a reverse osmosis treatment system (reverse osmosis treatment apparatus according to the modification) S2 including membrane unit lines.

In the reverse osmosis treatment system S2 illustrated in FIG. 8, the supply pump 11 and the high-pressure pump 12 are provided in common for the membrane unit lines and connected to each of the multiple membrane units disposed in parallel via pipes. On the other hand, the power recovery apparatus 18 and the booster pump 19 are provided for each of the multiple membrane units connected in parallel. In each membrane unit line, downstream of the bypass pipe valve V16 on the bypass pipe L16 is disposed a flow rate adjustment valve V1; on the permeated water pipe L23 of the second bank 20, a flow rate adjustment valve V2; and downstream of the power recovery apparatus 18 on the concentrated water pipe L22, the flow rate adjustment valve V3. The flow rate adjustment valves (V1, V2, V3) provide a back pressure and capable of adjusting the flow rate. In the reverse osmosis treatment system S2, the chemical cleaning apparatus U is provided in common for the membrane unit lines.

In the reverse osmosis treatment system S2, it is possible to clean reverse osmosis membrane modules disposed in a bank (10) included in a membrane unit line of the membrane unit lines connected in parallel while continuing the reverse osmosis treatment using reverse osmosis membrane modules disposed in the remaining bank. For the membrane unit including the reverse osmosis membrane modules being cleaned, the flow rate of the water to be treated supplied for the reverse osmosis treatment is adjusted by the degree of opening of the flow rate adjustment valve V1 and the output of the booster pump 19. The flow rate of the permeated water is adjusted by the degree of opening of the flow rate adjustment valve V2. Note that in the case where the flow rate of the water to be treated can be adjusted only by the output of the booster pump 19, the flow rate adjustment valve V1 does not need to be provided.

According to the reverse osmosis treatment system (reverse osmosis treatment apparatus according to the modification) S2 and the reverse osmosis treatment method using the same, it is possible to supply the water to be treated to the membrane unit lines connected in parallel using the common supply pump 11, and increase the pressure of the water to be treated to perform the reverse osmosis using the common high-pressure pump 12. Accordingly, in addition to more reduction of equipment cost, it is not necessary to adjust the output of the high-pressure pump 12 for each membrane unit line. The high-pressure pump 12 can be of a large type, which is advantageous to improve power efficiency.

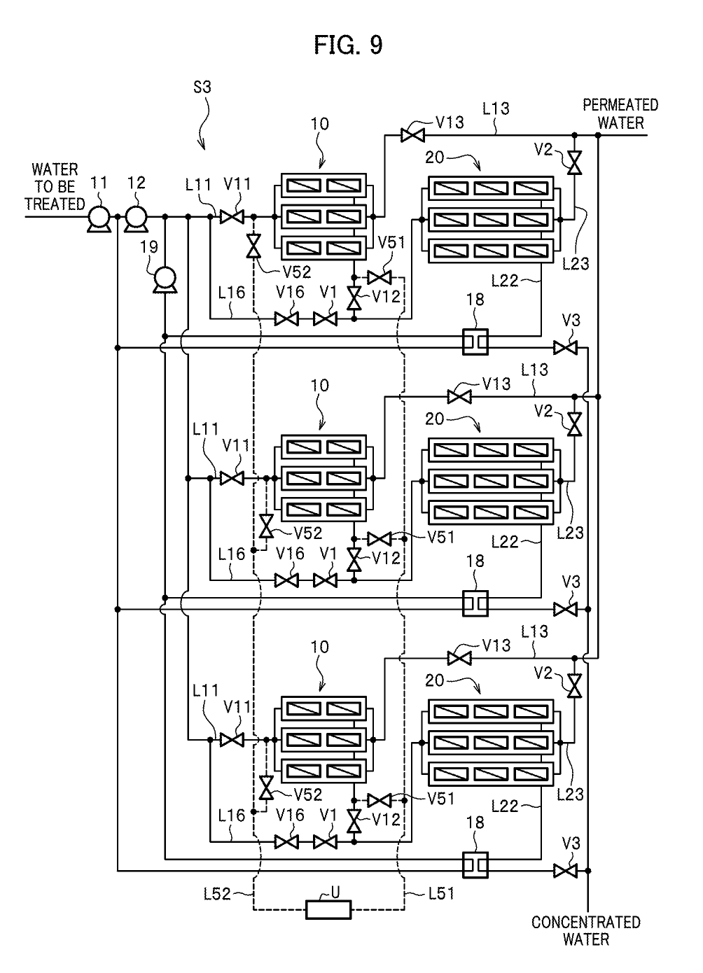

FIG. 9 is a diagram illustrating the configuration of a reverse osmosis treatment apparatus according to a third modification of the present invention.

As illustrated in FIG. 9, the foregoing reverse osmosis treatment apparatus (1, 2, 3) including the multiple-stage banks (10, 20) can form a membrane unit of a power recovery type, together with the supply pump (first pump) 11, high-pressure pump (second pump) 12, power recovery apparatus 18, and booster pump (third pump) 19. By connecting such membrane units in parallel with each other via pipes at the downstream side of the supply pump 11, it is also possible to form a reverse osmosis treatment system (reverse osmosis treatment apparatus according to a modification) S3 including membrane unit lines.

In the reverse osmosis treatment system S3 illustrated in FIG. 9, the supply pump 11, high-pressure pump 12, and booster pump 19 are provided in common for the membrane unit lines and connected to each of the multiple membrane units disposed in parallel via pipes. On the other hand, the power recovery apparatus 18 is provided for each of the multiple membrane units connected in parallel. In each membrane unit line, downstream of the bypass pipe valve V16 on the bypass pipe L16 is disposed the flow rate adjustment valve V1; on the second permeated water pipe L23 of the second bank 20, the flow rate adjustment valve V2; and downstream of the power recovery apparatus 18 on the concentrated water pipe L22, the flow rate adjustment valve V3. The flow rate adjustment valves (V1, V2, V3) provide a back pressure and capable of adjusting the flow rate. In the reverse osmosis treatment system S3, the chemical cleaning apparatus U is provided in common for the membrane unit lines.

In the reverse osmosis treatment system S3, it is possible to clean reverse osmosis membrane modules disposed in a bank (10) included in a membrane unit line of the membrane unit lines connected in parallel while continuing the reverse osmosis treatment using reverse osmosis membrane modules disposed in the remaining bank. For the membrane unit including the reverse osmosis membrane modules being cleaned, the flow rate of the water to be treated supplied for the reverse osmosis treatment is adjusted by the degree of opening of the flow rate adjustment valve V1. The flow rate of the permeated water is adjusted by the degree of opening of the flow rate adjustment valve V2. The flow rate of the water to be treated flowing into the power recovery apparatus 18 can be adjusted by the degree of opening of the flow rate adjustment valve V3 provided for each membrane unit line.

According to the reverse osmosis treatment system (reverse osmosis treatment apparatus according to the modification) S3 and the reverse osmosis treatment method using the same, it is possible to supply the water to be treated to the membrane unit lines connected in parallel using the common supply pump 11, separate part of the water to be treated to run it into the power recovery apparatuses 18 each provided for the respective membrane unit line, pressurize the water to be treated utilizing the residual pressure of the concentrated water, and then increase the pressure of the water to be treated to perform the reverse osmosis using the common booster pump 19. Accordingly, in addition to more reduction of equipment cost, it is not necessary to adjust the outputs of the high-pressure pump 12 and the booster pump 19 for each membrane unit line. The booster pump 19 can be of a large type, which is advantageous to improve power efficiency.

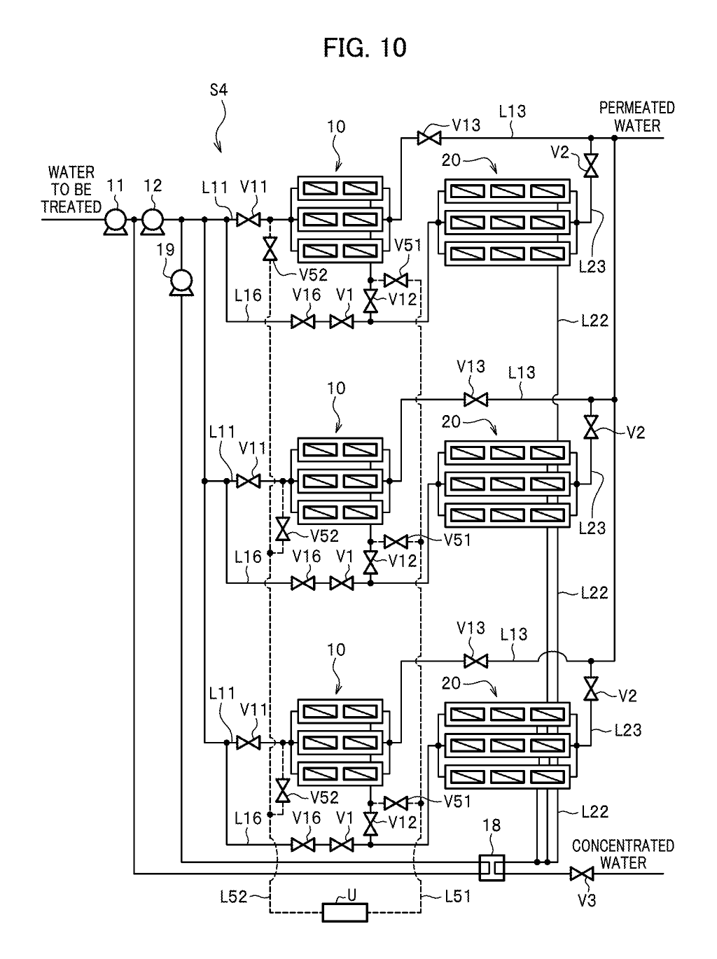

FIG. 10 is a diagram illustrating the configuration of a reverse osmosis treatment apparatus according to a fourth modification of the present invention.

As illustrated in FIG. 10, the foregoing reverse osmosis treatment apparatus (1, 2, 3) including the multiple-stage banks (10, 20) can form a membrane unit of a power recovery type, together with the supply pump (first pump) 11, high-pressure pump (second pump) 12, power recovery apparatus 18, and booster pump (third pump) 19. By connecting such membrane units in parallel with each other via pipes at the downstream side of the supply pump 11, it is also possible to form a reverse osmosis treatment system (reverse osmosis treatment apparatus according to a modification) S4 including membrane unit lines.

In the reverse osmosis treatment system S4 illustrated in FIG. 10, the supply pump 11, high-pressure pump 12, booster pump 19, and power recovery apparatus 18 are provided in common for the membrane unit lines. In addition, in each membrane unit line, downstream of the bypass pipe valve V16 on the bypass pipe L16 is disposed the flow rate adjustment valve V1; on the second permeated water pipe L23 of the second bank 20, the flow rate adjustment valve V2; and downstream of the power recovery apparatus 18 on the concentrated water pipe L22, the flow rate adjustment valve V3. The flow rate adjustment valves (V1, V2, V3) provide a back pressure and capable of adjusting the flow rate. In the reverse osmosis treatment system S4, the chemical cleaning apparatus U is provided in common for the membrane unit lines.

In the reverse osmosis treatment system S4, it is possible to clean reverse osmosis membrane modules disposed in a bank (10) included in a membrane unit line of the membrane unit lines connected in parallel while continuing the reverse osmosis treatment using reverse osmosis membrane modules disposed in the remaining bank. For the membrane unit including the reverse osmosis membrane modules being cleaned, the flow rate of the water to be treated supplied for the reverse osmosis treatment is adjusted by the degree of opening of the flow rate adjustment valve V1. The flow rate of the permeated water is adjusted by the degree of opening of the flow rate adjustment valve V2. The flow rate of the water to be treated flowing into the power recovery apparatus 18 can be adjusted by the degree of opening of the flow rate adjustment valve V3.

According to the reverse osmosis treatment system (reverse osmosis treatment apparatus according to the modification) S4 and the reverse osmosis treatment method using the same, it is possible to supply the water to be treated to the membrane unit lines connected in parallel using the common supply pump 11, separate part of the water to be treated and run it into the common recovery apparatus 18, pressurize the water to be treated utilizing the residual pressure of the concentrated water, and then increase the pressure of the water to be treated to perform the reverse osmosis using the common booster pump 19. Accordingly, in addition to more reduction of equipment cost, it is not necessary to adjust the outputs of the high-pressure pump 12 and the booster pump 19 for each membrane unit line. In the reverse osmosis treatment system S4, when cleaning the reverse osmosis membrane modules disposed in the bank (10) included in a membrane unit line, it is possible to continue the reverse osmosis treatment without greatly departing from a predetermined operation range, by adjusting the degree of opening of the flow rate adjustment valve V1 disposed on the supply path (bypass pipe L16) for the bank 20, and the flow rate adjustment valve V2 disposed on the permeated water flow path (second permeated water pipe L23) for the bank 20.

The present invention which has been described as above is not limited to the foregoing embodiments and modifications, and various changes can be made without departing from the spirit of the present invention. For example, the present invention is not necessarily limited to ones that include all the constituents included in the foregoing embodiments and modifications. It is possible to replace some of the constituents in the embodiments and modifications with other constituents, add some of the constituents in one of the embodiments and modifications to another aspect, and eliminate some of the constituents from the embodiments and modifications.

For example, the configurations of the reverse osmosis treatment apparatuses 1, 2, and 3 can be applied to any of the reverse osmosis treatment systems S1, S2, S3, and S4 according to the foregoing modifications. In addition, although the foregoing banks (10, 20) have two stages: the first bank 10 and the second bank 20, the banks may have two or more stages. In the case where two or more banks are included in series, the bypass pipe and the chemical cleaning pipe may be provided for an arbitrary number of the one or more stages.

In addition, although the foregoing reverse osmosis treatment systems S1, S2, S3, and S4 include three lines in parallel, the reverse osmosis treatment system may include an arbitrary number of two or more of lines in parallel. The reverse osmosis treatment system S1 may include multiple supply pumps 11 in parallel, each corresponding to the respective membrane unit; the reverse osmosis treatment system S2 may include multiple supply pumps 11 and high-pressure pumps 12 in parallel, each corresponding to the respective membrane unit; the reverse osmosis treatment system S3 may include multiple supply pumps 11, high-pressure pumps 12, and booster pumps 19 in parallel, each corresponding to the respective membrane unit; and the reverse osmosis treatment system S4 may include multiple supply pumps 11, high-pressure pumps 12, booster pumps 19, and power recovery apparatuses 18 in parallel, each corresponding to the respective membrane unit.

In addition, the devices such as the pipes, valves, and pumps included in the foregoing reverse osmosis treatment apparatuses 1, 2, and 3 and the foregoing reverse osmosis treatment systems S1, S2, S3, and S4 are not limited to the installation positions and connection states illustrated in the figures, but those devices may be at any positions and in any connection states unless the technical intentions are impaired.

What is claimed is:

1. A reverse osmosis treatment apparatus comprising
a membrane unit including one or more reverse osmosis membrane modules to perform reverse osmosis treatment on water to be treated, wherein
the membrane unit includes a plurality of banks connected in series, each bank including the one or more reverse osmosis membrane modules disposed in parallel,
at least one of the banks includes
a treatment water pipe for supplying the water to be treated to the bank,
a concentrated water pipe for discharging concentrated water separated by the bank, from the bank,
a treatment water pipe valve capable of closing the treatment water pipe, and
a concentrated water pipe valve capable of closing the concentrated water pipe,
a bypass pipe is connected between an upstream side of the treatment water pipe valve and a downstream side of the concentrated water pipe valve, the bypass pipe being capable of diverting the water to be treated, which is to be supplied to the bank, around the bank and draining the water to be treated, and
a chemical cleaning pipe is connected between a downstream side of the treatment water pipe valve and an upstream side of the concentrated water pipe valve, the chemical cleaning pipe being capable of supplying the reverse osmosis membrane modules disposed in the bank with chemical cleaning water for cleaning the reverse osmosis membrane modules.

2. The reverse osmosis treatment apparatus according to claim 1, wherein
the membrane unit includes
a first bank including the one or more reverse osmosis membrane modules to perform the reverse osmosis treatment on the water to be treated, and
a second bank including the one or more reverse osmosis membrane modules to perform the reverse osmosis treatment on concentrated water separated by the first bank,
the first bank of the first bank and the second bank includes
the treatment water pipe,
the concentrated water pipe,
the treatment water pipe valve, and
the concentrated water pipe valve,
the bypass pipe is capable of diverting the water to be treated, which is to be supplied to the first bank, around the first bank and supplying the water to be treated to the second bank, and
the chemical cleaning pipe is capable of supplying the reverse osmosis membrane modules disposed in the first bank with the chemical cleaning water.

3. The reverse osmosis treatment apparatus according to claim 1, wherein
the membrane unit includes
a first bank including the one or more reverse osmosis membrane modules to perform the reverse osmosis treatment on the water to be treated, and
a second bank including the one or more reverse osmosis membrane modules to perform the reverse osmosis treatment on concentrated water separated by the first bank,
the second bank of the first bank and the second bank includes
the treatment water pipe,
the concentrated water pipe,
the treatment water pipe valve, and
the concentrated water pipe valve,
the bypass pipe is capable of diverting the water to be treated, which is to be supplied to the second bank, around the second bank and draining the water to be treated, and
the chemical cleaning pipe is capable of supplying the reverse osmosis membrane modules disposed in the second bank with the chemical cleaning water.

4. The reverse osmosis treatment apparatus according to claim 1, wherein
the membrane unit includes
a first bank including the one or more reverse osmosis membrane modules to perform the reverse osmosis treatment on the water to be treated, and
a second bank including the one or more reverse osmosis membrane modules to perform the reverse osmosis treatment on concentrated water separated by the first bank,
the first bank and the second bank include
the treatment water pipe,
the concentrated water pipe,
the treatment water pipe valve, and
the concentrated water pipe valve,
the bypass pipe includes
a first bypass pipe capable of diverting the water to be treated, which is to be supplied to the first bank, around the first bank and supplying the water to be treated to the second bank, and
a second bypass pipe capable of diverting the concentrated water, which is to be supplied to the second bank, around the second bank and draining the concentrated water,
the chemical cleaning pipe includes
a first chemical cleaning pipe capable of supplying the reverse osmosis membrane modules disposed in the first bank with the chemical cleaning water, and
a second chemical cleaning pipe capable of supplying the reverse osmosis membrane modules disposed in the second bank with the chemical cleaning water,
while the reverse osmosis treatment is being performed on the water to be treated, the water to be treated which is to be supplied to one bank of the first bank and the second bank is diverted around the one bank and drained, and the reverse osmosis treatment is performed using a remaining bank, and
while the reverse osmosis treatment is being performed on the water to be treated using the remaining bank of the first bank and the second bank, the chemical cleaning water is supplied to the one bank, around which the water to be treated is diverted, to clean the reverse osmosis membrane modules.

5. A reverse osmosis treatment system including a plurality of the reverse osmosis treatment apparatuses according to claim 2, which are connected in parallel, the reverse osmosis treatment system further comprising:
a first pump to supply water to be treated;
a second pump disposed downstream of the first pump, to increase pressure of the water to be treated to pass the water to be treated through a reverse osmosis membrane by reverse osmosis;
a power recovery apparatus to increase the pressure of the water to be treated which is to be supplied to the first bank, utilizing residual pressure of concentrated water separated by the second bank; and
a third pump to pressurize the water to be treated the pressure of which has been increased by the power recovery apparatus, wherein
the second pump, the power recovery apparatus, and the third pump are included in each of the reverse osmosis treatment apparatuses connected in parallel.

6. A reverse osmosis treatment system including a plurality of the reverse osmosis treatment apparatuses according to claim 2, which are connected in parallel, the reverse osmosis treatment system further comprising:
a first pump to supply water to be treated;
a second pump disposed downstream of the first pump, to increase pressure of the water to be treated to pass the water to be treated through a reverse osmosis membrane by reverse osmosis;
a power recovery apparatus to increase the pressure of the water to be treated which is to be supplied to the first bank, utilizing residual pressure of concentrated water separated by the second bank; and
a third pump to pressurize the water to be treated the pressure of which has been increased by the power recovery apparatus, wherein
the power recovery apparatus and the third pump are included in each of the reverse osmosis treatment apparatuses connected in parallel, and
the second pump is connected to each of the reverse osmosis treatment apparatuses connected in parallel.

7. A reverse osmosis treatment system including a plurality of the reverse osmosis treatment apparatuses according to claim 2, which are connected in parallel, the reverse osmosis treatment system further comprising:
a first pump to supply water to be treated;
a second pump disposed downstream of the first pump, to increase pressure of the water to be treated to pass the water to be treated through a reverse osmosis membrane by reverse osmosis;
a power recovery apparatus to increase the pressure of the water to be treated which is to be supplied to the first bank, utilizing residual pressure of concentrated water separated by the second bank; and
a third pump to pressurize the water to be treated the pressure of which has been increased by the power recovery apparatus, wherein
the second pump and the third pump are included in each of the reverse osmosis treatment apparatuses connected in parallel, and
the power recovery apparatus is connected to each of the reverse osmosis treatment apparatuses connected in parallel.

8. A reverse osmosis treatment system including a plurality of the reverse osmosis treatment apparatuses according to claim 2, which are connected in parallel, the reverse osmosis treatment system further comprising:
a first pump to supply water to be treated;
a second pump disposed downstream of the first pump, to increase pressure of the water to be treated to pass the water to be treated through a reverse osmosis membrane by reverse osmosis;
a power recovery apparatus to increase the pressure of the water to be treated which is to be supplied to the first bank, utilizing residual pressure of concentrated water separated by the second bank; and
a third pump to pressurize the water to be treated the pressure of which has been increased by the power recovery apparatus, wherein
the second pump and the power recovery apparatus are included in each of the reverse osmosis treatment apparatuses connected in parallel, and
the third pump is connected to each of the reverse osmosis treatment apparatuses connected in parallel.

9. A reverse osmosis treatment method using a reverse osmosis treatment apparatus including
a membrane unit including one or more reverse osmosis membrane modules to perform reverse osmosis treatment on water to be treated, in which
the membrane unit includes a plurality of banks connected in series, each bank including the one or more reverse osmosis membrane modules disposed in parallel,
the reverse osmosis treatment method comprising:
performing the reverse osmosis treatment on the water to be treated using the banks;
while performing the reverse osmosis treatment on the water to be treated, diverting the water to be treated, which is to be supplied to one bank of the banks, around the one bank and draining the water to be treated, and performing the reverse osmosis treatment on the water to be treated using a remaining bank of the banks; and
while performing the reverse osmosis treatment on the water to be treated using the remaining bank of the banks, supplying chemical cleaning water to the one bank to clean the reverse osmosis membrane modules.
